(19) United States
(12) Patent Application Publication
(10) Pub. No.: US 2016/0011661 A1
(43) Pub. Date: Jan. 14, 2016

(54) ELECTRONIC DEVICE, METHOD, AND COMPUTER PROGRAM PRODUCT

(71) Applicant: Kabushiki Kaisha Toshiba, Tokyo (JP)

(72) Inventors: Akira TANAKA, Tokyo (JP); Kouichi OGI, Hanno Saitama (JP)

(21) Appl. No.: 14/565,321

(22) Filed: Dec. 9, 2014

(30) Foreign Application Priority Data
Jul. 11, 2014 (JP) 2014-143565

(51) Int. Cl. G06F 3/01; G09G 5/18; G09G 5/10

(52) U.S. Cl. CPC G06F 3/014; G09G 5/10; G09G 5/18

(57) ABSTRACT

According to one embodiment, an electronic device includes a receiver and circuitry. The receiver is configured to receive, from another electronic device, information relating to peripheral illuminance of the other electronic device. The circuitry is configured to change brightness of a display based on the information relating to peripheral illuminance of the other electronic device and intensity of a signal received by the receiver from the other electronic device. The other electronic device is a wearable electronic device.

### CROSS-REFERENCE TO RELATED APPLICATIONS

This application is based upon and claims the benefit of priority from Japanese Patent Application No. 2014-143565, filed Jul. 11, 2014, the entire contents of which are incorporated herein by reference.

### FIELD

Embodiments described herein relates generally to an electronic device, a method, and a computer program product.

### BACKGROUND

Conventionally, there has been known an electronic device that performs control based on a signal transferred between an electronic device and other electronic device.

When the electronic device receives a signal from the other electronic device, the conventional technique controls illumination with an assumption that a user is present. However, the conventional technique does not take into account signal intensity.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of environment in which each device is used according to an embodiment;

FIG. 2 is an exemplary diagram of hardware configurations of a personal computer (PC) and a mobile device in the embodiment;

FIG. 3 is an exemplary diagram of each configuration realized on a central processing unit (CPU) by executing a control program, in the embodiment;

FIG. 4 is an exemplary diagram of a relationship between the PC and the mobile device in the embodiment;

FIG. 5 is an exemplary flowchart of processing in the PC, when the PC communicates with the mobile device, in the embodiment;

FIG. 6 is an exemplary flowchart of processing in the PC when the PC communicates with a mobile device, according to a first modification; and

FIG. 7 is an exemplary flowchart of processing in a tablet terminal when the tablet terminal communicates with a mobile device, according to a second modification.

### DETAILED DESCRIPTION

In general, according to one embodiment, an electronic device comprises a receiver and circuitry. The receiver is configured to receive, from another electronic device, information relating to peripheral illuminance of the other electronic device. The circuitry is configured to change brightness of a display based on the information relating to peripheral illuminance of the other electronic device and intensity of a signal received by the receiver from the other electronic device. The other electronic device is a wearable electronic device.

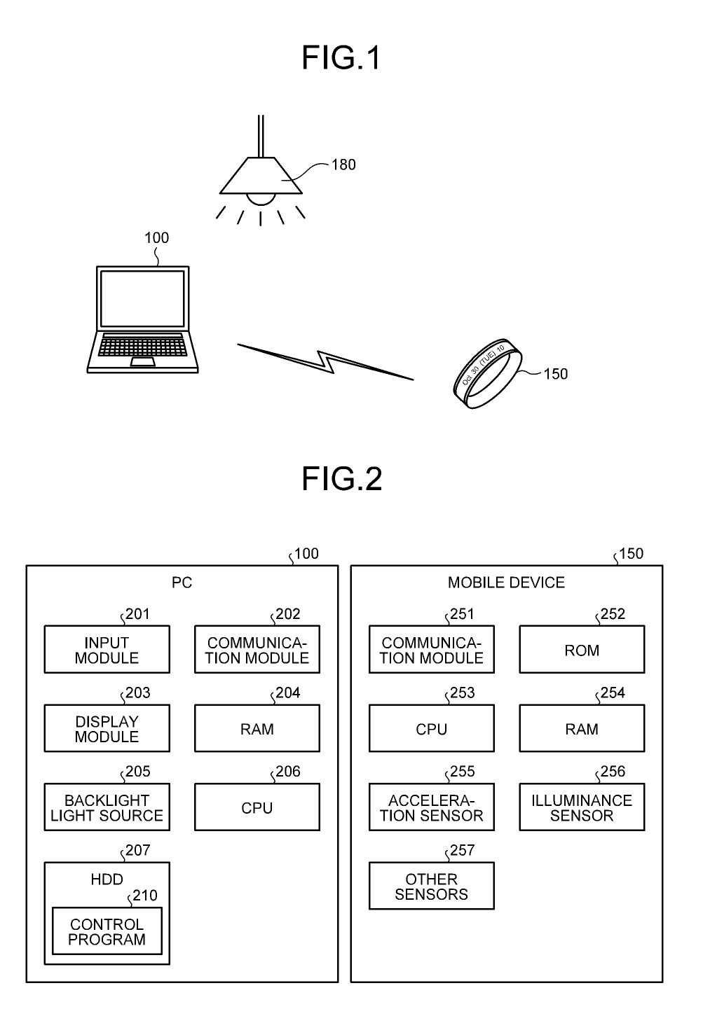

Embodiments will be described. FIG. 1 is a view illustrating environment in which devices are used according to an embodiment. In an example as illustrated in FIG. 1, description is made using a personal computer (PC) 100, a mobile device 150, and an illumination device 180 provided in a room.

The PC 100 is used as an example of an electronic device. It is sufficient that the electronic device is an electronic device comprising a backlight (light source) for a display or a keyboard. Other examples of the electronic device include a tablet terminal, a television broadcasting display device, and/or the like.

A mobile device 150 is one example of other electronic device that is wearable and carriable by a user. Although a wearable computer worn on the user's arm or finger is used as the mobile device 150, as an example, in the embodiment, it is sufficient that the mobile device 150 is an electronic device that is wearable by the user. Furthermore, the mobile device 150 may be an electronic device that is carriable by the user.

The PC 100 is configured to be capable of making wireless communication with the mobile device 150. Examples of a communication scheme that is used in the embodiment include Bluetooth (registered trademark). Alternatively, a communication scheme other than Bluetooth (registered trademark) may be used.

The mobile device 150 in the embodiment incorporates therein various sensors such as an illuminance sensor, and can detect a condition of external environment (for example, room) in which the user is present. In the example illustrated in FIG. 1, the mobile device 150 detects illuminance of the room with the illumination device 180 by an illuminance sensor. The mobile device 150 uses the illuminance detected by the illuminance sensor. Furthermore, the mobile device 150 transmits a signal containing illuminance information to the PC 100 through wireless communication. The PC 100 receives the illuminance information as information relating to peripheral illuminance that is measured by the mobile device 150. This enables the PC 100 to perform control based on the illuminance around the mobile device 150.

FIG. 2 is a diagram illustrating hardware configurations of the PC 100 and the mobile device 150 in the embodiment.

The PC 100 as illustrated in FIG. 2 comprises an input module 201, a communication module 202, a display 203, a random access memory (RAM) 204, a backlight light source 205, a CPU 206, and a hard disc drive (HDD) 207.

The input module 201 is an input interface such as a keyboard and a touch panel that is provided for receiving operation input from the user.

The communication module 202 is a communication interface that is used to communicate with other electronic devices (for example, mobile device 150).

The display 203 is a display that displays various pieces of information as video. In the embodiment, as an example, a liquid crystal display is used as the display 203.

The backlight light source 205 is configured as a light source that illuminates the display 203 with light from the rear surface side. The backlight light source 205 in the embodiment adjusts the brightness of the liquid crystal display as the display 203. The backlight light source 205 in the embodiment may be used as a light source for lighting the keyboard as the input module 201.

The RAM 204 is configured to be used as an operation region when a CPU 15 performs various pieces of arithmetic processing.

The CPU 206 is configured to perform various pieces of arithmetic processing by executing various computer programs for controlling the respective modules of the PC 100.

The HDD 207 is configured to store therein various computer programs that are executed by the CPU 206 and various pieces of data. For example, the HDD 207 in the embodiment comprises a control program 210.

The mobile device 150 comprises a communication module 251, a read only memory (ROM) 252, a CPU 253, a RAM 254, an acceleration sensor 255, an illuminance sensor 256, and other sensors 257.

The communication module 251 is a communication interface that is used to communicate with other electronic devices (for example, a PC 100).

The ROM 252 is configured to store therein various computer programs that are executed by the CPU 253 and various pieces of data.

The CPU 253 is configured to perform various pieces of arithmetic processing by executing various computer programs for controlling the respective modules of the mobile device 150.

The RAM 254 is configured to be used as an operation region when the CPU 253 performs various pieces of arithmetic processing.

The acceleration sensor 255 is a sensor for detecting acceleration indicating motion of the mobile device 150. The acceleration detected by the acceleration sensor 255 is output to the CPU 253. With this configuration, the CPU 253 can acquire the acceleration generated in the mobile device 150.

The illuminance sensor 256 is a sensor for detecting peripheral illuminance that is measured by the mobile device 150. The illuminance detected by the illuminance sensor 256 is output to the CPU 253. With this configuration, the CPU 253 can acquire the illuminance of the external environment of the mobile device 150.

The other sensors 257 are various sensors (other than the acceleration sensor 255 and the illuminance sensor 256) that are provided to the mobile device 150. Detection results by the other sensors 257 are output to the CPU 253. With this configuration, the CPU 253 can acquire the current condition of the mobile device 150.

The mobile device 150 in the embodiment outputs various pieces of information (to a display (not illustrated), for example) in accordance with the condition of the user who carries the mobile device 150. Furthermore, various pieces of information can be transmitted and received between the mobile device 150 and the PC 100 with wireless communication in the embodiment.

The PC 100 in the embodiment receives a signal containing a current condition (for example, illuminance and acceleration) acquired by the mobile device 150 and performs various controls. In order to perform various controls, the CPU 206 executes the control program 210 at the time of activation of the PC 100. The control program 210 is a program that keeps being resident and enables various controls to be executed based on the signal received from the mobile device 150.

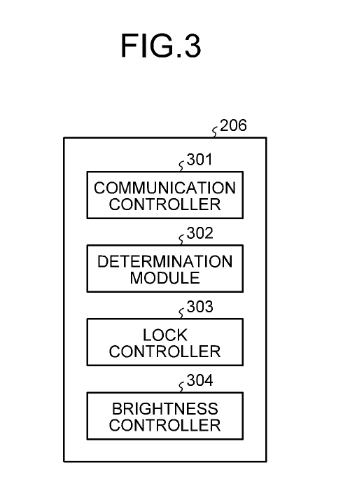

The CPU 206 of the PC 100 executes the control program 210 so as to realize various configurations. FIG. 3 is a diagram illustrating configurations realized on the CPU 206 by executing the control program 210.

As illustrated in FIG. 3, the CPU 206 executes the control program 210 so as to realize a communication controller 301, a determination module 302, a lock controller 303, and a brightness controller 304.

The communication controller 301 controls transmission and reception of a signal (information) to and from other electronic devices (for example, the mobile device 150) using the communication module 202.

The determination module 302 determines the intensity of a received signal when the communication controller 301 controls to receive the signal from other electronic device.

When the determination module 302 determines the strengths of the signal received from other electronic device such as the mobile device 150, the determination module 302 may determine the strengths of the signal based on whether the intensity of the signal is larger than a predetermined threshold. However, in some cases, the intensity of the transmitted signal may differ among other electronic devices. Therefore, according to the present embodiment, when a user wearing the mobile device 150 performs an input operation using the input module 201 of the PC 100, the communication controller 301 acquires the intensity of the signal received from the mobile device 150. Next, the determination module 302 sets a reference value for the mobile device 150 (hereinafter, the set reference value is referred to as a set value) for determining the strength of the signal based on the acquired intensity of the signal.

That is to say, when the input operation is made on the PC 100, the signal intensity that is received by the communication module 202 from the mobile device 150 is considered to be the highest because the user is in the vicinity of the PC 100. The determination module 302 in the embodiment sets, to the set value, a value obtained by lowering the intensity of the signal acquired while the input operation is made by a predetermined level. It should be noted that the set value is set for each of other electronic devices.

Next, the determination module 302 determines whether the signal intensity of the signal received by the communication module 202 from the mobile device 150 is higher than the set value.

The lock controller 303 controls to lock or unlock the PC 100 based on the determination result of the determination module 302. The lock controller 303 in the embodiment controls to lock the PC 100 when the intensity of the signal received by the communication module 202 from other electronic device is lower than the set value. On the other hand, the lock controller 303 controls to unlock the PC 100 when the intensity of the received signal is equal to or higher than the set value. Although description is made for an example where the lock controller 303 controls to lock the entire PC 100 in the embodiment, it is sufficient that it limits execution of at least a part of functions. In the same manner, the lock controller 303 is not limited to unlock the entire PC 100 and it is sufficient that it enables at least a part of the functions to be executed.

The brightness controller 304 controls the brightness of the backlight light source 205 of the PC 100 based on the determination result of the determination module 302. When the intensity of the signal received by the communication module 202 from the mobile device 150 is lower than the set value, the brightness controller 304 controls the backlight light source 205 of the PC 100 to output the darkest light or controls to turn off the backlight light source 205. When the intensity of the received signal is higher than the set value, the brightness controller 304 controls the backlight light source 205 of the PC 100 to output brighter light than that when the intensity of the received signal is lower than the set value.

In addition, when the intensity of the received signal is higher than the set value, in other words, when the PC 100 is unlocked, the brightness controller 304 in the embodiment adjusts the brightness of the backlight light source 205 based on illuminance information transmitted from the mobile device 150.

An example of adjustment of the brightness based on the illuminance information in the embodiment is described. The brightness controller 304 determines whether a state in which the peripheral illuminance measured by the mobile device 150 is relatively high or low in comparison with the illuminance as a reference of the brightness of the backlight light source 205 lasts for a predetermined period of time. For example, the relatively high or low state can indicate the case in which the currently measured peripheral illuminance is higher or lower than the illuminance as the reference of the brightness of the backlight light source 205 by a predetermined difference value or more. When the brightness controller 304 determines that the relatively high or low state lasts for the predetermined period of time, the brightness controller 304 changes the brightness of the display 203 with the backlight light source 205. This can prevent acute change in the brightness.

Thus, the CPU 206 of the PC 100 changes the brightness of the display 203 (display) using the peripheral illuminance information measured by the mobile device 150 and the intensity of the signal received by the communication module 251 from the mobile device 150. In the embodiment, in order to change the brightness of the display 203, the brightness controller 304 adjusts the brightness of the backlight light source 205.

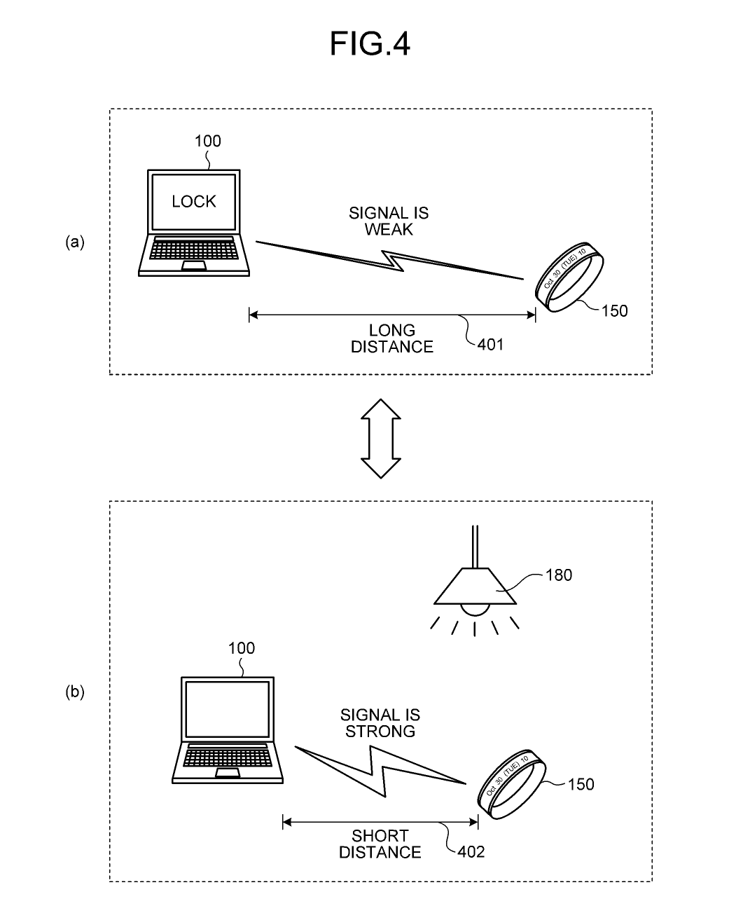

FIG. 4 is a diagram illustrating a relationship between the PC 100 and the mobile device 150 in the embodiment. As illustrated in (a) of FIG. 4, in the case in which a distance 401 between the mobile device 150 and the PC 100 is large, the determination module 302 determines that the signal intensity is lower than the set value when the PC 100 receives a signal from the mobile device 150. In this case, the lock controller 303 controls to lock the PC 100. Furthermore, the brightness controller 304 controls the backlight light source 205 to output the darkest light or controls to turn off the backlight light source 205. That is to say, when the signal intensity is lower than the set value, it is assumed that the user is far away from the PC 100 and thereby does not use the PC 100. Accordingly, the above-mentioned control is performed on the PC 100. This can achieve improvement in security and power saving control.

As illustrated in (b) of FIG. 4, in the case in which a distance 402 between the mobile device 150 and the PC 100 is small, the determination module 302 determines that the signal intensity is higher than the set value when the PC 100 receives the signal from the mobile device 150. In this case, the lock controller 303 controls to unlock the PC 100. Furthermore, the brightness controller 304 controls the backlight light source 205 to output brighter light than that in the case of (a) of FIG. 4 and adjusts the brightness of the backlight light source 205 based on the illuminance information transmitted from the mobile device 150. That is to say, when the signal intensity is higher than the set value, it is assumed that the user is in the vicinity of the PC 100 for using the PC 100. Accordingly, the above-mentioned control is performed on the PC 100.

In particular, the brightness controller 304 in the embodiment adjusts the brightness of the backlight light source 205 based on the illuminance information received by the communication controller 301 from the mobile device 150. This can provide a screen that is displayed by the display 203 with appropriate brightness to the user.

The PC 100 in the embodiment performs the above-mentioned control so as to adjust the brightness based on the illuminance information detected by the illuminance sensor 256 of the mobile device 150 even when the PC 100 comprises no illuminance sensor. This can reduce the number of components of the PC 100 and reduce the production cost.

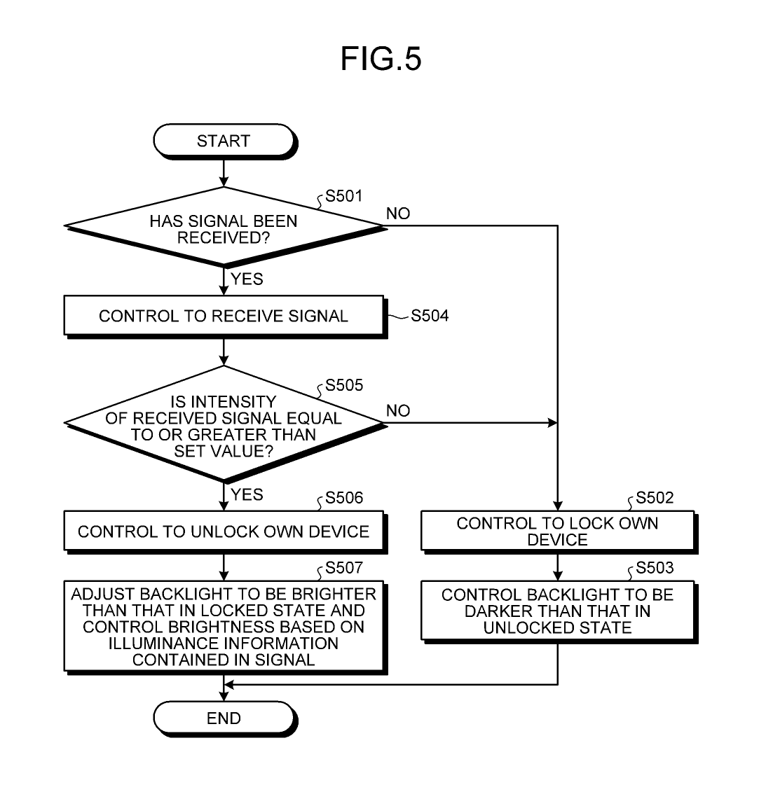

The following describes processing in the PC 100 in the embodiment when the PC 100 communicates with the mobile device 150. FIG. 5 is a flowchart of the above-mentioned processing on the PC 100 in the embodiment.

First, the communication controller 301 determines whether a signal has been received from the mobile device 150 through the communication module 202 (S501). When the communication controller 301 determines that the signal has not been received (No at S501), the lock controller 303 controls to lock the PC 100 (own device) so as to prevent third parties from using the PC 100 (S502). Next, the brightness controller 304 controls the brightness of the backlight by the backlight light source 205 to be lower than that in the unlocked state (for example, controls it to be the lowest) (S503).

On the other hand, when the communication controller 301 determines that the signal has been received from the mobile device 150 through the communication module 202 (Yes at S501), the communication controller 301 controls to receive the signal from the mobile device 150 (S504). The received signal contains illuminance information by the illuminance sensor 256, acceleration information by the acceleration sensor 255, and detection results by the other sensors 257.

Subsequently, the determination module 302 determines whether the intensity of the received signal is equal to or higher than the set value (S505). When the determination module 302 determines that the intensity is lower than the set value (No at S505), lock control and control for setting the brightness of the backlight to be lower than that in the unlocked state are performed (S502 and S503).

On the other hand, when the determination module 302 determines that the intensity of the received signal is equal to or higher than the set value (Yes at S505), the lock controller 303 controls to unlock the PC 100 (own device) such that the user in the vicinity of the PC 100 can use it (S506).

Next, the brightness controller 304 adjusts the brightness of the backlight by the backlight light source 205 to be higher than that in the locked state, and controls the brightness based on the illuminance information contained in the received signal (S507).

When the PC 100 is made into the locked state as a result of the above-mentioned control, the PC 100 may shift to a power saving mode where the power supply of the display 203 is turned off, a clock of the CPU 206 is stopped, and so on.

### First Modification

While the embodiment describes an example in which the brightness of the backlight by the backlight light source 205 is adjusted based on the illuminance information, the embodiment is not limited to the method of adjusting the brightness of the backlight by the backlight light source 205 based on the illuminance information. In a first modification, the brightness of the backlight is adjusted by the backlight light source 205 based on the acceleration of the mobile device 150. The PC 100 in the first modification is assumed to have the same configuration as that of the PC 100 in the embodiment and description thereof is omitted.

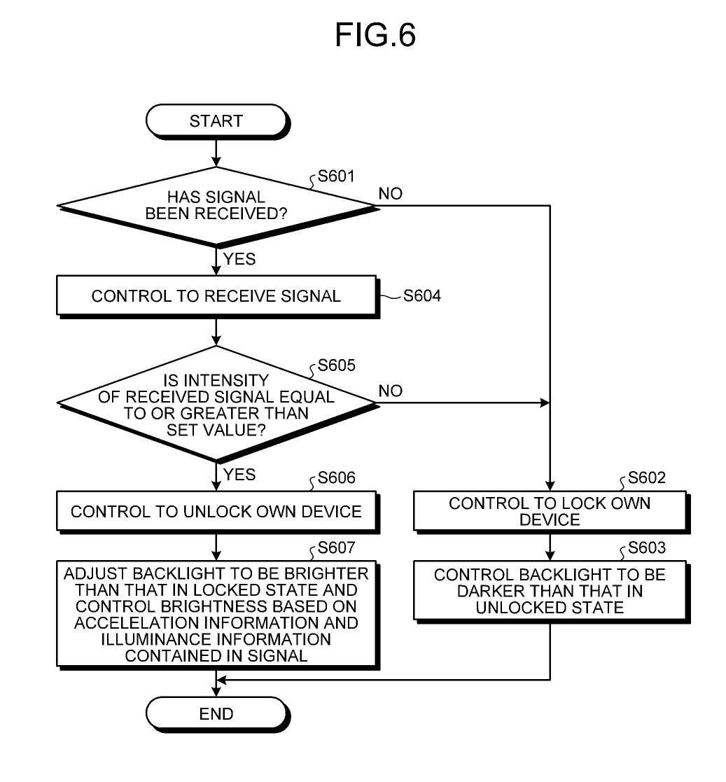

The following describes processing in the PC 100 in the first modification when the PC 100 communicates with the mobile device 150. FIG. 6 is a flowchart illustrating procedures of the above-mentioned processing in the PC 100 in the modification.

In the processing illustrated in FIG. 6, the processing at S507 is different among the pieces of processing at S501 to S507 in FIG. 5. That is to say, after the determination module 302 determines that the intensity of the received signal is higher than the set value (Yes at S605) and the lock controller 303 controls to unlock the own device (S606), the brightness controller 304 adjusts the brightness of the backlight by the backlight light source 205 to be higher than that in the locked state and controls the brightness based on the acceleration information and the illuminance information contained in the received signal (S607).

For example, when the user performs the input operation on the PC 100, the mobile device 150 worn by the user operates in accordance with the input operation. Next, the acceleration sensor 255 of the mobile device 150 detects the acceleration as a parameter relating to the operation and transmits a signal containing the acceleration information to the PC 100. Thus, the PC 100 receives the acceleration information as information relating to the operation of the mobile device 150.

The brightness controller 304 of the PC 100 controls the brightness of the backlight light source 205 based on the acceleration information and the illuminance information. That is to say, when the user is in the vicinity of the PC 100 and the acceleration information is higher than a predetermined acceleration after the backlight light source 205 is adjusted based on the illuminance information, it is assumed that the user is performing the input operation on the PC 100 and the brightness controller 304 controls the backlight light source 205 to output brighter light than that when the acceleration information is equal to or lower than the predetermined acceleration. This can make the screen of the display 203 to be bright while the user is performing the input operation. On the other hand, when the acceleration information is lower than the predetermined acceleration, it is assumed that the user is not performing the input operation on the PC 100 and it is less likely that the user views the screen on the display 203. Based on this, the brightness controller 304 controls the brightness of the screen on the display 203 to be darker than a value when it controls the backlight light source 205 based on the illuminance information.

The modification is not limited to such control that when the acceleration information is higher than the predetermined acceleration, the backlight light source 205 is caused to output brighter light than that when the acceleration information is equal to or lower than the predetermined acceleration. For example, when the user moves while carrying the PC 100, the acceleration sensor 255 can detect the acceleration corresponding to the movement. When such acceleration is detected, the brightness controller 304 controls the backlight light source 205 to output dark light preferably.

As specific processing, when the determination module 302 determines that the acceleration information is larger than the predetermined acceleration, the brightness controller 304 controls the backlight light source 205 to output darker light than that when the acceleration information is equal to or lower than the predetermined acceleration. That is to say, when the user moves while carrying the PC 100, it is considered that the user does not use the PC 100. Based on this, the brightness controller 304 controls the backlight to be dark. This control has an effect when the electronic device is a tablet terminal or the like particularly.

In the modification, the brightness is adjusted based on a result of combination of the illuminance information and the acceleration information. Alternatively, the brightness controller 304 may adjust the brightness using only the acceleration information contained in the received signal.

Furthermore, the display 203 of the PC 100 may display a setting screen for setting the brightness adjustment based on the strength of the signal intensity, the illuminance information, and the acceleration information. In this case, the input module 201 receives an input operation onto the setting screen. Thereafter, the brightness controller 304 controls the brightness based on the result of the input operation. This can control the brightness in accordance with the preference of the user.

### Second Modification

Although the brightness control is switched based on whether the signal intensity is higher than one set value in the above-mentioned embodiment and first modification, the above-mentioned embodiment and first modification do not limit the number of set values for controlling the brightness to one. In a second modification, description is made for the case where a plurality of set values are present.

In the modification, an example in which a tablet terminal is applied to the electronic device is described. The configuration of the tablet terminal is assumed to be the same as the configuration of the PC 100 and description of the respective constituent components is omitted.

When the electronic device is the tablet terminal, the user operates the tablet terminal in the user's hand and views video images and the like while attaching it to a cradle or the like depending on conditions. In this modification, the brightness of a light source is adjusted based on the difference in the condition. For example, brightness is controlled to be the highest when the user operates the tablet terminal in the user's hand, is controlled to be an intermediate level when the user views video and the like while attaching it to the cradle or the like, and is controlled to be the lowest when the user is distant from the tablet terminal.

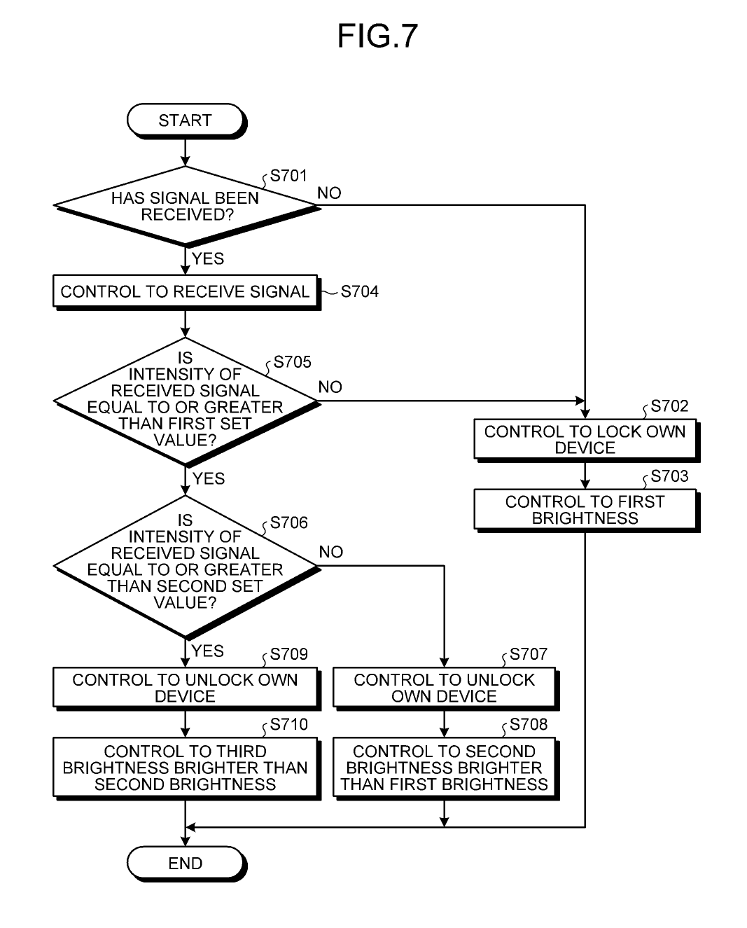

The following describes processing in the tablet terminal in the second modification when the tablet terminal communicates with the mobile device 150. FIG. 7 is a flowchart illustrating the above-mentioned processing in the tablet terminal in the second modification.

First, the communication controller 301 determines whether a signal has been received from the mobile device 150 through the communication module 202 (S701). When the communication controller 301 determines that the signal has not been received (No at S701), the lock controller 303 controls to lock the PC 100 (own device) so as to prevent third parties from using the PC 100 (S702). Next, the brightness controller 304 controls the brightness of the backlight by the backlight light source 205 to first brightness (for example, to be the lowest) (S703).

On the other hand, the communication controller 301 determines that the signal has been received from the mobile device 150 through the communication module 202 (Yes at S701), the communication controller 301 controls to receive the signal from the mobile device 150 (S704).

Subsequently, the determination module 302 determines whether the intensity of the received signal is equal to or higher than a first set value (S705). When the determination module 302 determines that the intensity is lower than the first set value (No at S705), lock control and control for setting the brightness of the backlight to the first brightness are performed (S702 and S703). That is to say, lock control and power saving control are performed on the assumption that the user is not in the vicinity of the tablet terminal.

On the other hand, when the determination module 302 determines that the intensity of the received signal is equal to or higher than the first set value (Yes at S705), the determination module 302 then determines whether the intensity of the received signal is equal to or higher than a second set value (S706). It should be noted that the second set value is set to be larger than the first set value.

Next, when the determination module 302 determines that the intensity of the received signal is lower than the second set value (No at S706), the lock controller 303 controls to unlock the tablet terminal (own device) (S707).

The brightness controller 304 controls the brightness of the backlight by the backlight light source 205 to be second brightness higher than the first brightness (S708). For example, the brightness controller 304 controls to set the brightness of the tablet terminal that is appropriate for reproducing moving images and the like at S708.

On the other hand, when the determination module 302 determines that the intensity of the received signal is equal to or higher than the second set value (Yes at S706), the lock controller 303 controls to unlock the tablet terminal (own device) (S709).

The brightness controller 304 controls the brightness of the backlight by the backlight light source 205 to be third brightness higher than the second brightness (S710). For example, the brightness controller 304 controls to set the brightness that is appropriate for operating the tablet terminal at S708.

Although two set values are set in the modification, the number of set values is not limited to two and may be equal to or more than three.

Although the brightness is adjusted on the tablet terminal based on the distance between the tablet terminal and the user in the modification, as described above, the adjustment of the brightness is not limited to be performed on the tablet terminal. For example, it may be applied to a PC or may be applied to a television broadcasting display device.

When the adjustment of the brightness is applied to the television broadcasting display device, the brightness of the backlight is controlled based on the intensity of the signal that is transmitted from the mobile device attached to the user. For example, when the intensity of the signal from the mobile device is equal to or lower than the first set value, it is considered that the user does not view it and control for setting the brightness to be the lowest (first brightness) is performed. When the intensity of the signal from the mobile device is higher than the first set value and is lower than the second set value, it is considered that the user views it from a distant place therefrom and control for setting the brightness to be the highest (second brightness) is performed. Furthermore, when the intensity of the signal from the mobile device is higher than the second set value, it is considered that the user views it in the vicinity thereof and control for setting the brightness to be low (third brightness) is performed. It should be noted that the second brightness is set to be higher than the third brightness and the third brightness is set to be higher than the first brightness.

In the above-mentioned embodiment and modifications, the brightness is controlled based on the signal intensity so as to achieve the screen display in accordance with the condition of the user. This can provide comfortable usage environment to the user.

For example, when the electronic device such as the PC 100 is in the unlocked state, brightness can be automatically adjusted in accordance with the illuminance of the external environment. This enables the user to view the screen easily without making adjustment or the like.

In this case, when the electronic device such as the PC 100 comprises a communication module for communicating with other electronic devices, it can acquire results of various sensors. Furthermore, the electronic device can adjust the brightness based on the results of various sensors. With this configuration, the production cost incurred in providing the sensors can be reduced.

When the user attaches the mobile device 150 to his (her) arm or finger, the current condition of the user can be acquired more appropriately by the mobile device 150 than the case where a sensor is provided on the PC 100 or the like. When the brightness of the light source is controlled based on the information from the mobile device 150 as described above, the brightness control that is more appropriate for the user's environment can be achieved.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to receive, from another electronic device, information relating to peripheral illuminance of the other electronic device; and
circuitry configured to change brightness of a display based on the information relating to peripheral illuminance of the other electronic device and intensity of a signal received by the receiver from the other electronic device, wherein the other electronic device is a wearable electronic device.

2. The electronic device of claim 1, wherein the circuitry is further configured to limit execution of at least one function of the electronic device when intensity of a signal received by the receiver from the other electronic device is lower than a threshold and enable execution of at least one function of the electronic device when intensity of a signal received by the receiver from the other electronic device is higher than or equal to the threshold.

3. The electronic device of claim 1, wherein the circuitry is further configured to change the brightness of the display when the information relating to peripheral illuminance of the other electronic device indicates that the illuminance lasts for a period higher or lower than a reference value, wherein the reference value is a value for setting the brightness of the display.

4. The electronic device of claim 1, wherein
the receiver is further configured to receive information relating to movement of the other electronic device, and
the circuitry is further configured to change the brightness of the display based on the information relating to the movement of the other electronic device.

5. A method for controlling an electronic device comprising:
receiving, from another electronic device, information relating to peripheral illuminance of the other electronic device; and
changing brightness of a display based on the information relating to peripheral illuminance of the other electronic device and intensity of a signal received by a receiver from the other electronic device, wherein the other electronic device is a wearable electronic device.

6. The method of claim 5, further comprising:
limiting execution of at least one function of the electronic device when the intensity of the signal received from the other electronic device is lower than a threshold and enabling execution of at least one function of the electronic device when the intensity of the signal is higher than or equal to the threshold.

7. The method of claim 5, further comprising:
changing the brightness of the display when the information relating to peripheral illuminance of the other electronic device indicates that the illuminance lasts for a period higher or lower than a reference value, wherein the reference value is a value for setting the brightness of the display.

8. The method of claim 5, further comprising:
receiving information relating to movement of the other electronic device; and
changing the brightness of the display based on the information relating to the movement of the other electronic device.

9. A computer program product having a non-transitory computer readable medium including programmed instructions for controlling an electronic device capable of communicating with another electronic device, wherein the instructions, when executed by a computer, cause the computer to:
receive, from the other electronic device, information relating to peripheral illuminance of the other electronic device; and
change brightness of a display based on the information relating to peripheral illuminance of the other electronic device and intensity of a signal received by a receiver from the other electronic device, wherein the other electronic device is a wearable electronic device.

10. The computer program product of claim 9, wherein the instructions further cause the computer to
limit execution of at least one function of the electronic device when the intensity of the signal received from the other electronic device is lower than a first threshold and enable execution of at least one function of the electronic device when the intensity of the signal is higher than or equal to the first threshold.

11. The computer program product of claim 9, wherein the instructions further cause the computer to change the brightness of the display when the information relating to peripheral illuminance of the other electronic device indicates that the illuminance lasts for a period higher or lower than a reference value, wherein the reference value is a value for setting the brightness of the display.

12. The computer program product of claim 9, wherein the instructions further cause the computer to
receive information relating to movement of the other electronic device; and
change the brightness of the display based on the information relating to the movement of the other electronic device.
